(19) United States
(12) Patent Application Publication
(10) Pub. No.: US 2007/0196405 A1
(43) Pub. Date: Aug. 23, 2007

(54) Fibrous structures comprising volatile agents

(75) Inventors: Thomas Alan Wilker, City Norwood, OH (US); Robert James Green, Bethel, OH (US); Douglas William Gledhill, St. Charles, MO (US); Jerry Ray Stephens, Hamilton, OH (US); Joseph Jay Bullock, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/709,499

(22) Filed: Feb. 22, 2007

Related U.S. Application Data
(60) Provisional application No. 60/775,632, filed on Feb. 22, 2006.

(51) Int. Cl. A01N 25/34

(52) U.S. Cl. 424/402

(57) ABSTRACT

Fibrous structures that comprise volatile agents, sanitary tissue products comprising such fibrous structures, articles of manufacture comprising such fibrous structures and processes for making same are provided. More particularly, fibrous structures that comprise unrestrained volatile agents, sanitary tissue products comprising such fibrous structures, articles of manufacture comprising such fibrous structures and processes for making same are provided.

### CROSS REFERENCE TO RELATED APPLICATIONS

This application claims the benefit of U.S. Provisional Application No. 60/775,632 filed Feb. 22, 2006.

### FIELD OF THE INVENTION

The present invention relates to fibrous structures that comprise volatile agents, sanitary tissue products comprising such fibrous structures, articles of manufacture comprising such fibrous structures and processes for making same. More particularly, the present invention relates to fibrous structures that comprise unrestrained volatile agents, sanitary tissue products comprising such fibrous structures, articles of manufacture comprising such fibrous structures and processes for making same.

### BACKGROUND OF THE INVENTION

Formulators of sanitary tissue products, especially facial tissues, have tried unsuccessfully in the past to produce fibrous structures, especially sanitary tissue products, more especially facial tissues, and/or articles of manufacture comprising such fibrous structures that are able to provide consumers a consumer recognizable olfactory benefit during use.

Attempts to meet the consumers' needs for a consumer recognizable olfactory benefit from fibrous structures and/or articles of manufacture comprising fibrous structures have included associating fibrous structures and/or containers comprising fibrous structures with volatile agents such as synthetic and/or natural, fragrances (perfumes), flavors, cooling sensates and/or menthol, that under certain conditions and/or in certain forms and/or at certain levels provide an olfactory response to a consumer.

Formulators have found that certain volatile agents, such as menthol, under certain conditions can provide an unpleasant olfactory response to a consumer. In addition, formulators have found that certain volatile agents, such as menthol, under certain conditions can volatilize too quickly thus providing little, if any, olfactory response to a consumer.

Attempts to manage the negatives associated with volatile agents, such as menthol, include prior art executions where restrained volatile agents, such as encapsulated volatile agents and/or solid volatile agents, were added on and/or into fibrous structures. The encapsulation of the volatile agent ensures that the volatile agents are very slowly released if released at all and/or that only relatively low levels of volatiles are released and/or that the volatile agents are released only under certain conditions, such as elevated temperatures (usually not the case during use by a user of the fibrous structure) and/or upon friction with a user's skin and/or pressure by a user's hand that breaks the capsule and releases the volatile agent. Such prior art executions have failed miserably to provide consumers a consumer recognizable olfactory benefit.

Other prior art executions include restraining volatile agents by mixing the volatile agents, especially in solid and/or crystalline form, such as menthol powders and/or particulates, with a lotion composition and then applying the lotion/volatile agent composition on and/or into the fibrous structure. Again, such executions have failed to provide consumers a consumer recognizable olfactory benefit.

Accordingly, there continues to be a long felt need for fibrous structures, especially sanitary tissue products, more especially facial tissues, that provide consumers a consumer recognizable olfactory benefit during use.

### SUMMARY OF THE INVENTION

The present invention fulfills the needs described above by providing fibrous structures and/or sanitary tissue products comprising fibrous structures and/or articles of manufacture comprising fibrous structures that provide consumers a consumer recognizable olfactory benefit, for example an olfactory benefit upon use by a consumer wherein the consumer perceives that the consumer's nasal passages are providing greater air passage through the nasal passages than before the olfactory benefit and/or than what prior art fibrous structures have been able to provide. In one example, the consumer feels that the fibrous structures are helping them feel like they are breathing better. In another example, the consumer feels that the fibrous structures are helping them feel cared for, especially when they have a cold. In still another example, the consumer feels that the fibrous structures are providing soothing comfort, especially when they have a cold. In yet another example, the consumer feels that the fibrous structures are providing an appealing new benefit; namely, an olfactory benefit.

In one example of the present invention, a fibrous structure comprising a volatile agent wherein the fibrous structure provides a user of the fibrous structure an olfactory benefit upon use wherein the user perceives that the user's nasal passages are providing greater air passage through the nasal passages than before the olfactory benefit, is provided.

In another example of the present invention, a fibrous structure comprising an unrestrained volatile agent, is provided.

In even another example of the present invention, a fibrous structure comprising an oil system comprising one or more essential oils and one or more volatile agents, is provided.

In yet another example of the present invention, a fibrous structure comprising a lotion composition and one or more unrestrained volatile agents, is provided.

In still another example of the present invention, an article of manufacture comprising a container and one or more fibrous structures according to the present invention is provided.

In still yet another example of the present invention, a fibrous structure comprising at least 0.150% by weight of a volatile agent, especially an unrestrained volatile agent, is provided.

In even still yet another example of the present invention, a single- or multi-ply sanitary tissue product comprising a fibrous structure according to the present invention is provided.

In another example of the present invention, a process for making a fibrous structure that provides a consumer recognizable olfactory benefit upon use by a consumer wherein the consumer perceives that the consumer's nasal passages are providing greater air passage through the nasal passages than before the olfactory benefit, the process comprising the step of associating a fibrous structure with a volatile agent, is provided.

Accordingly, the present invention provides fibrous structures and/or sanitary tissue products comprising fibrous structures and/or articles of manufacture comprising fibrous structures that provide consumers a consumer recognizable olfactory benefit, for example an olfactory benefit upon use by a consumer wherein the consumer perceives that the consumer's nasal passages are providing greater air passage through the nasal passages than before the olfactory benefit and/or than what prior art fibrous structures have been able to provide.

### BRIEF DESCRIPTION OF THE DRAWINGS

FIG. 1 is a schematic representation of a fibrous structure according to the present invention;

FIG. 2 is cross-sectional view of FIG. 1 taken along line 2-2;

FIG. 3 is a schematic representation of an article of manufacture according to the present invention.

### DETAILED DESCRIPTION OF THE INVENTION

“Fiber” as used herein means an elongate particulate having an apparent length greatly exceeding its apparent diameter, i.e. a length to diameter ratio of at least about 10. Fibers having a non-circular cross-section are common; the “diameter” in this case may be considered to be the diameter of a circle having cross-sectional area equal to the cross-sectional area of the fiber. More specifically, as used herein, “fiber” refers to papermaking fibers. The present invention contemplates the use of a variety of papermaking fibers, such as, for example, natural fibers or synthetic fibers, or any other suitable fibers, and any combination thereof.

Natural papermaking fibers useful in the present invention include animal fibers, mineral fibers, plant fibers and mixtures thereof. Animal fibers may, for example, be selected from the group consisting of: wool, silk and mixtures thereof. Plant fibers may, for example, be derived from a plant selected from the group consisting of: wood, cotton, cotton linters, flax, sisal, abaca, hemp, hesperaloe, jute, bamboo, bagasse, kudzu, corn, sorghum, gourd, agave, loofah and mixtures thereof.

Wood fibers; often referred to as wood pulps include chemical pulps, such as kraft (sulfate) and sulfite pulps, as well as mechanical and semi-chemical pulps including, for example, groundwood, thermomechanical pulp, chemi-mechanical pulp (CMP), chemi-thermomechanical pulp (CTMP), neutral semi-chemical sulfite pulp (NSCS). Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified and/or layered fibrous structure. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

The wood pulp fibers may be short (typical of hardwood fibers) or long (typical of softwood fibers). Nonlimiting examples of short fibers include fibers derived from a fiber source selected from the group consisting of Acacia, Eucalyptus, Maple, Oak, Aspen, Birch, Cottonwood, Alder, Ash, Chemy, Elm, Hickory, Poplar, Gum, Walnut, Locust, Sycamore, Beech, Catalpa, Sassafras, Gmelina, Albizia, Anthocephalus, and Magnolia. Nonlimiting examples of long fibers include fibers derived from Pine, Spruce, Fir, Tamarack, Hemlock, Cypress, and Cedar. Softwood fibers derived from the kraft process and originating from more-northern climates may be preferred. These are often referred to as northern softwood kraft (NSK) pulps.

Synthetic fibers may be selected from the group consisting of: wet spun fibers, dry spun fibers, melt spun (including melt blown) fibers, synthetic pulp fibers and mixtures thereof. Synthetic fibers may, for example, be comprised of cellulose (often referred to as “rayon”); cellulose derivatives such as esters, ether, or nitrous derivatives; polyolefins (including polyethylene and polypropylene); polyesters (including polyethylene terephthalate); polyamides (often referred to as “nylon”); acrylics; non-cellulosic polymeric carbohydrates (such as starch, chitin and chitin derivatives such as chitosan); and mixtures thereof.

“Fibrous structure” as used herein means a structure that comprises one or more fibers. Nonlimiting examples of processes for making fibrous structures include known wet-laid papermaking processes and air-laid papermaking processes. Such processes typically include steps of preparing a fiber composition, oftentimes referred to as a fiber slurry in wet-laid processes, either wet or dry, and then depositing a plurality of fibers onto a forming wire or belt such that an embryonic fibrous structure is formed, drying and/or bonding the fibers together such that a fibrous structure is formed, and/or further processing the fibrous structure such that a finished fibrous structure is formed. For example, in typical papermaking processes, the finished fibrous structure is the fibrous structure that is wound on the reel at the end of papermaking, but before converting thereof into a sanitary tissue product.

Nonlimiting types of fibrous structures according to the present invention include conventionally felt-pressed fibrous structures; pattern densified fibrous structures; and high-bulk, uncompacted fibrous structures. The fibrous structures may be of a homogeneous or multilayered (two or three or more layers) construction; and the sanitary tissue products made therefrom may be of a single-ply or multi-ply construction.

The fibrous structures may be post-processed, such as by embossing and/or calendaring and/or folding and/or printing images thereon. The fibrous structures may be through-air-dried fibrous structures or conventionally dried fibrous structures. The fibrous structures may be creped or uncreped.

“Sanitary tissue product” comprises one or more fibrous structures, converted or not, that is useful as a wiping implement for post-urinary and post-bowel movement cleaning (toilet tissue), for otorhinolaryngological discharges (facial tissue and/or disposable handkerchiefs), and multi-functional absorbent and cleaning uses (absorbent towels and/or wipes).

“Ply” or “Plies” as used herein means an individual finished fibrous structure optionally to be disposed in a substantially contiguous, face-to-face relationship with other plies, forming a multiple ply finished fibrous structure product and/or sanitary tissue product. It is also contemplated that a single fibrous structure can effectively form two “plies” or multiple “plies”, for example, by being folded on itself.

“Layered” as used herein means that a fibrous structure comprises two or more layers of different fiber compositions (long, short, hardwood, softwood, curled/kinked, linear). Layered fibrous structures are well known in the art as exemplified in U.S. Pat. Nos. 3,994,771, 4,300,981 and 4,166,001 and European Patent Publication No. 613 979 A1. Fibers typically being relatively long softwood and relatively short hardwood fibers are used in multi-layered fibrous structure papermaking processes. Multi-layered fibrous structures suitable for the present invention may comprise at least two superposed layers, an inner layer and at least one outer layer contiguous with the inner layer. Preferably, the multi-layered fibrous structures comprise three superposed layers, an inner or center layer, and two outer layers, with the inner layer located between the two outer layers. The two outer layers preferably comprise a primary filamentary constituent of about 60% or more by weight of relatively short papermaking fibers having an average fiber length, L, of less than about 1.5 mm. These short papermaking fibers are typically hardwood fibers, preferably hardwood Kraft fibers, especially Acacia pulp fibers alone or in combination with other hardwood pulp fibers such as Eucalyptus pulp fibers. The inner layer preferably comprises a primary filamentary constituent of about 60% or more by weight of relatively long papermaking fibers having an average fiber length, L, of greater than or equal to about 1.5 mm. These long papermaking fibers are typically softwood fibers, preferably, northern softwood Kraft fibers.

The fiber compositions forming the layers of the fibrous structure may comprise any mixture of fiber types. The fibrous structures of the present invention may comprise at least two and/or at least three and/or at least four and/or at least five layers.

“Surface of a fibrous structure” as used herein means that portion of the fibrous structure that is exposed to the external environment. In other words, the surface of a fibrous structure is that portion of the fibrous structure that is not completely surrounded by other portions of the fibrous structure.

“User Contacting Surface” as used herein means that portion of the fibrous structure and/or surface treating composition and/or lotion composition present directly and/or indirectly on the surface of the fibrous structure that is exposed to the external environment. In other words, it is that surface formed by the fibrous structure including any surface treating composition and/or lotion composition present directly and/or indirectly on the surface of the fibrous structure that contacts an opposing surface, such as a user's skin, when used by a user. For example, it is that surface formed by the fibrous structure including any surface treating composition and/or lotion composition present directly and/or indirectly on the surface of the fibrous structure that contacts a user's skin when a user wipes his/her skin with the fibrous structure of the present invention.

In one example, the user contacting surface, especially for a textured and/or structured fibrous structure, such as a through-air-dried fibrous structure and/or an embossed fibrous structure, may comprise raised areas and recessed areas of the fibrous structure. In the case of a through-air-dried, pattern densified fibrous structure the raised areas may be knuckles and the recessed areas may be pillows and vice versa. Accordingly, the knuckles may, directly and/or indirectly, comprise the surface treating composition and lotion composition and the pillows may be void of the surface treating composition and the lotion composition and vice versa so that when a user contacts the user's skin with the fibrous structure, only the lotion composition contacts the user's skin. A similar case is true for embossed fibrous structures where the embossed areas may, directly and/or indirectly, comprise the surface treating composition and the lotion composition and the non-embossed areas may be void of the surface treating composition and the lotion composition and vice versa.

The user contacting surface may be present on the fibrous structure and/or sanitary tissue product before use by the user and/or the user contacting surface may be created/formed prior to and/or during use of the fibrous structure and/or sanitary tissue product by the user, such as upon the user applying pressure to the fibrous structure and/or sanitary tissue product as the user contacts the user's skin with the fibrous structure and/or sanitary tissue product.

“Consumer recognizable olfactory benefit” as used herein means that a consumer (i.e., user) of the fibrous structure is able to recognize an olfactory benefit upon use of the fibrous structure. The olfactory benefit is any response in the consumer's olfactory senses that is different from the initial state the consumer's olfactory senses were in before using the fibrous structure. During use, a consumer will place the fibrous structure in close proximity to the consumer's nasal passage openings and inhale. In one example, the olfactory benefit provided by the fibrous structures and/or sanitary tissue products and/or articles of manufacture of the present invention are greater than the olfactory benefit provided by any prior art fibrous structure and/or sanitary tissue product. In one example, the consumer may have swollen and/or clogged or partially clogged nasal passages (for example, when a consumer is experiencing allergies and/or cold/stuffy nose symptoms), when the consumer recognizable olfactory benefit is determined. In other words, one time to determine if a consumer is receiving a consumer recognizable olfactory benefit, especially one that is greater than what prior art fibrous structures have been able to provide, is when the consumer is experiencing partial and/or substantially complete closure of the consumer's nasal passages.

“Restrained Volatile Agent” as used herein means a volatile agent that is in a form, either neat or in combination with other materials, such that the volatile agent, when associated with (on and/or in) a fibrous structure, is not able to provide a consumer a consumer recognizable olfactory benefit upon use of the fibrous structure, especially a consumer recognizable olfactory benefit that is greater than any olfactory benefit provided by prior art fibrous structures. Nonlimiting examples of restrained volatile agents include volatile agents that are solids, volatile agents that are encapsulated by within material that prevents/inhibits the volatile agents from providing a consumer recognizable olfactory benefit, and/or volatile agents that are mixed with other materials to form a composition, such as a lotion composition comprising one or more volatile agents, wherein the composition prevents/inhibits the volatile agents from providing a consumer recognizable olfactory benefit.

“Unrestrained Volatile Agent” as used herein means a volatile agent that is in a form, neat or in combination with other materials, such that the volatile agent, when associated with (on and/or in) a fibrous structure, is able to provide a consumer a consumer recognizable olfactory benefit upon use of the fibrous structure, especially a consumer recognizable olfactory benefit that is greater than any olfactory benefit provided by prior art fibrous structures. Nonlimiting example of unrestrained volatile agents include volatile agents that are in liquid form and volatile agents that are dissolved within an oil system, such as an essential oil system. In one example, a fibrous structure of the present invention may comprise a lotion composition comprising a volatile agent, such that the volatile agent is a restrained volatile agent, and the fibrous structure may further comprise an unrestrained volatile agent.

“Associating” as used herein means to bring an agent, such as a volatile agent, in close proximity and/or to directly contact a substrate, such as a container surface and/or a fibrous structure, such that a consumer recognizable olfactory benefit is provided to a consumer during use of the container and/or fibrous structure. Nonlimiting examples of associating include spraying, dipping, brushing, printing, slot extruding and the like.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Fibrous Structure

The fibrous structure of the present invention may comprise a volatile agent and/or a lotion composition and/or a surface softening composition. When the fibrous structure comprises a lotion composition and a surface softening composition, the surface softening composition may be sandwiched between the lotion composition, which forms a user contacting surface, and the surface of the fibrous structure. The lotion composition and the surface softening composition may be phase registered such that the user contacting surface comprises lotion composition regions and fibrous structure regions.

When the fibrous structure comprises a lotion composition without a surface softening, the lotion composition is in contact with the surface of the fibrous structure. The user contacting surface may be comprised entirely of the lotion composition or it may be comprised of regions of lotion composition and regions of fibrous structure.

When the fibrous structure comprises a surface softening composition without a lotion composition, the surface softening composition is in contact with the surface of the fibrous structure. The user contacting surface may be comprised entirely of the surface softening composition or it may be comprised of regions of surface softening composition and regions of the fibrous structure.

In one example of the present invention, the fibrous structure comprises a lotion composition. Without wishing to be bound by theory, it is believed that the lotion composition facilitates the migration of a volatile agent into and/or throughout the fibrous structure when the volatile agent comes in contact with the lotion composition on the fibrous structure.

In another example, the volatile agent is uniformly distributed throughout the fibrous structure and/or across the surface of the fibrous structure and/or user contacting surface of the fibrous structure.

In yet another example, the volatile agent is extractable from the fibrous structure. When a lotion composition is also present in/on the fibrous structure, the volatile agent, at least a portion of the volatile agent, may be separate and discrete from the lotion composition. In other words, the volatile agent may be an unrestrained volatile agent.

Other optional ingredients may also be present in and/or on the fibrous structure. Such optional ingredients may include additional essential oils and other ingredients such as cedarleaf oil, nutmeg oil, turpentine oil, thymol, wet strength agents, dry strength agents, antiviral agents, including organic acids, perfumes, especially long lasting and/or enduring perfumes, antibacterial agents, opacifiers, wetting agents, lint resisting agents, absorbency-enhancing agents, polyol polyesters, antimigration agents, polyhydroxy plasticizers and mixtures thereof. Such optional ingredients may be added to the fiber furnish, the embryonic fibrous web and/or the fibrous structure.

Such optional ingredients may be present in the fibrous structures at any level based on the dry weight of the fibrous structure. The optional ingredients may be present in the fibrous structures at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

### Volatile Agent

The volatile agent of the present invention may comprise a material that volatilizes sufficiently such that a consumer recognizable olfactory benefit is provided to a consumer (i.e., user) upon inhaling the volatile agent. In one example, the volatile agent provides a consumer recognizable olfactory benefit under substantially ambient conditions, for example at a temperature of about 73° F.±4° F. (about 23° C.±2.2° C.). In another example, a volatile agent suitable for use in the fibrous structures of the present invention includes a volatile agent that permits a consumer, upon inhaling the volatile agent, to perceive that the consumer's nasal passages are permitting greater air flow through the nasal passages or in other words, that the consumer perceives its nasal passages are opening.

The volatile agent may be natural or synthetic. The volatile agent of the present invention may be an essential oil. An essential oil is a volatile oil. An essential oil usually has the characteristic odor or flavoring of the plant from which it is obtained.

The volatile agent of the present invention may be a cooling sensate. A cooling sensate is a material that causes a cold feeling on a user's (human's) skin. Nonlimiting examples of suitable cooling sensates may include isopropyl-N-2,3-trimethylbutyramide and/or isopulegol.

In one example of the present invention, the volatile agent is void of any isopropyl-N-2,3-trimethylbutyramide and isopulegol.

Nonlimiting examples of suitable volatile agents include menthol (such as L-menthol), camphor, eucalyptus oil, lavender oil (such as Bulgarian Lavender Oil) and mixtures thereof.

In one example of the present invention, the volatile agent of the present invention comprises menthol. The menthol may be in its liquid form.

In another example of the present invention, the volatile agent of the present invention comprises camphor.

In yet another example of the present invention, the volatile agent of the present invention comprises eucalyptus oil.

In still another example of the present invention, the volatile agent of the present invention comprises two or more of menthol, camphor and eucalyptus oil. The menthol may be in its liquid form.

Two or more volatile agents may be mixed together to form a homogeneous composition of volatile agents.

The volatile agent may be present on a container, such as on an interior surface of the container, housing one or more fibrous structures of the present invention. If present on the container, the volatile agent may be transferable to one or more fibrous structures within the container. The level of volatile agent present on the container may be any suitable level such that one or more fibrous structures within the container provides a consumer recognizable olfactory benefit upon use by a consumer. In one example, the volatile agent, especially in liquid form, is applied to an interior surface of the container such that one or more fibrous structures is able to contact the volatile agent thus permitting transfer of the volatile agent to the one or more fibrous structures.

The volatile agent may be present within the void volume of a container housing one or more fibrous structure of the present invention. If present within the void volume of the container, the volatile agent may be present in the void volume at a level such that a consumer recognizable olfactory benefit is provided to a consumer.

The volatile agent may be present on and/or in the fibrous structure of the present invention. When present on and/or in the fibrous structure, the fibrous structure may comprise at least about 0.150% and/or at least about 0.175% and/or at least about 0.185% and/or at least about 0.2% and/or at least about 0.3% and/or at least about 0.4% and/or at least about 0.5% by weight of the fibrous structure. In one example of the present invention, the fibrous structure comprises about 0.185% by weight of the volatile agent. In another example of the present invention, the fibrous structure comprises about 0.555% by weight of the volatile agent.

In another example, a fibrous structure in accordance with the present invention comprises at least about 0.01 g and/or at least about 0.05 g and/or at least about 0.1 g to about 5 g and/or to about 3 g and/or to about 2 g and/or to about 1.3 g and/or to about 1.1 g by dry weight of the fibrous structure of a volatile agent.

### Lotion Composition

The fibrous structure of the present may comprise a lotion composition.

The lotion composition may comprise oils and/or emollients and/or waxes and/or immobilizing agents. In one example, the lotion composition comprises from about 10% to about 90% and/or from about 30% to about 90% and/or from about 40% to about 90% and/or from about 40% to about 85% of an oil and/or emollient. In another example, the lotion composition comprises from about 10% to about 50% and/or from about 15% to about 45% and/or from about 20% to about 40% of an immobilizing agent. In another example, the lotion composition comprises from about 0% to about 60% and/or from about 5% to about 50% and/or from about 5% to about 40% of petrolatum.

The lotion compositions may be heterogeneous. They may contain solids, gel structures, polymeric material, a multiplicity of phases (such as oily and water phase) and/or emulsified components. It may be difficult to determine precisely the melting temperature of the lotion composition, i.e. difficult to determine the temperature of transition between the liquid form, the quasi-liquid from, the quasi-solid form and the solid form. The terms melting temperature, melting point, transition point and transition temperature are used interchangeably in this document and have the same meaning.

The lotion compositions may be semi-solid, of high viscosity so they do not substantially flow without activation during the life of the product or gel structures.

The lotion compositions may be shear thinning and/or they may strongly change their viscosity around skin temperature to allow for transfer and easy spreading on a user's skin.

The lotion compositions may be in the form of emulsions and/or dispersions. The lotion composition may be a transferable lotion composition.

In one example of a lotion composition, the lotion composition has a water content of less than about 20% and/or less than 10% and/or less than about 5% or less than about 0.5%.

In another example, the lotion composition may have a solids content of at least about 15% and/or at least about 25% and/or at least about 30% and/or at least about 40% to about 100% and/or to about 95% and/or to about 90% and/or to about 80%.

A nonlimiting example of a suitable lotion composition of the present invention comprises a chemical softening agent, such as an emollient, that softens, soothes, supples, coats, lubricates, or moisturizes the skin. The lotion composition may sooth, moisturize, and/or lubricate a user's skin.

The lotion composition may comprise an oil and/or an emollient. Nonlimiting examples of suitable oils and/or emollients include glycols (such as propylene glycol and/or glycerine), polyglycols (such as triethylene glycol), petrolatum, fatty acids, fatty alcohols, fatty alcohol ethoxylates, fatty alcohol esters and fatty alcohol ethers, fatty acid ethoxylates, fatty acid amides and fatty acid esters, hydrocarbon oils (such as mineral oil), squalane, fluorinated emollients, silicone oil (such as dimethicone) and mixtures thereof.

Nonlimiting examples of emollients useful in the present invention can be petroleum-based, fatty acid ester type, alkyl ethoxylate type, or mixtures of these materials. Suitable petroleum-based emollients include those hydrocarbons, or mixtures of hydrocarbons, having chain lengths of from 16 to 32 carbon atoms. Petroleum based hydrocarbons having these chain lengths include petrolatum (also known as “mineral wax,” “petroleum jelly” and “mineral jelly”). Petrolatum usually refers to more viscous mixtures of hydrocarbons having from 16 to 32 carbon atoms. A suitable Petrolatum is available from Witco, Corp., Greenwich, Conn. as White Protopet® 1 S.

Suitable fatty acid ester emollients include those derived from long chain C₁₂-C₂₈ fatty acids, such as C₁₆-C₂₂ saturated fatty acids, and short chain C₁-C₈ monohydric alcohols, such as C₁-C₃ monohydric alcohols. Nonlimiting examples of suitable fatty acid ester emollients include methyl palmitate, methyl stearate, isopropyl laurate, isopropyl myristate, isopropyl palmitate, and ethylhexyl palmitate. Suitable fatty acid ester emollients can also be derived from esters of longer chain fatty alcohols (C₁₂-C₂₈, such as C₁₂-C₁₆) and shorter chain fatty acids e.g., lactic acid, such as lauryl lactate and cetyl lactate.

Suitable fatty acid ester type emollients include those derived from C₁₂-C₂₈ fatty acids, such as C₁₆-C₂₂ saturated fatty acids, and short chain (C₁-C₈ and/or C₁-C₃) monohydric alcohols. Representative examples of such esters include methyl palmitate, methyl stearate, isopropyl laurate, isopropyl myristate, isopropyl palmitate, and ethylhexyl palmitate. Suitable fatty acid ester emollients can also be derived from esters of longer chain fatty alcohols (C₁₂-C₂₈ and/or C₁₂-C₁₆) and shorter chain fatty acids e.g., lactic acid, such as lauryl lactate and cetyl lactate.

Suitable alkyl ethoxylate type emollients include C₁₂-C₁₈ fatty alcohol ethoxylates having an average of from 3 to 30 oxyethylene units, such as from about 4 to about 23. Nonlimiting examples of such alkyl ethoxylates include laureth-3 (a lauryl ethoxylate having an average of 3 oxyethylene units), laureth-23 (a lauryl ethoxylate having an average of 23 oxyethylene units), ceteth-10 (acetyl ethoxylate having an average of 10 oxyethylene units), steareth-2 (a stearyl ethoxylate having an average of 2 oxyethylene units) and steareth-10 (a stearyl ethoxylate having an average of 10 oxyethylene units). These alkyl ethoxylate emollients are typically used in combination with the petroleum-based emollients, such as petrolatum, at a weight ratio of alkyl ethoxylate emollient to petroleum-based emollient of from about 1:1 to about 1:3, preferably from about 1:1.5 to about 1:2.5.

The lotion compositions of the present invention may include an “immobilizing agent”, so-called because they are believed to act to prevent migration of the emollient so that it can remain primarily on the surface of the fibrous structure to which it is applied so that it may deliver maximum softening benefit as well as be available for transferability to the user's skin. Suitable immobilizing agents for the present invention can comprise polyhydroxy fatty acid esters, polyhydroxy fatty acid amides, and mixtures thereof. To be useful as immobilizing agents, the polyhydroxy moiety of the ester or amide should have at least two free hydroxy groups. It is believed that these free hydroxy groups are the ones that co-crosslink through hydrogen bonds with the cellulosic fibers of the tissue paper web to which the lotion composition is applied and homo-crosslink, also through hydrogen bonds, the hydroxy groups of the ester or amide, thus entrapping and immobilizing the other components in the lotion matrix. Nonlimiting examples of suitable esters and amides will have three or more free hydroxy groups on the polyhydroxy moiety and are typically nonionic in character. Because of the skin sensitivity of those using paper products to which the lotion composition is applied, these esters and amides should also be relatively mild and non-irritating to the skin.

Suitable polyhydroxy fatty acid esters for use in the present invention will have the formula:

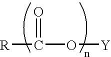

wherein R is a C₅-C₃₁ hydrocarbyl group, such as a straight chain C₇-C₁₉ alkyl or alkenyl and/or a straight chain C₉-C₁₇ alkyl or alkenyl and/or a straight chain C₁₁-C₁₇ alkyl or alkenyl, or mixture thereof; Y is a polyhydroxyhydrocarbyl moiety having a hydrocarbyl chain with at least 2 free hydroxyls directly connected to the chain; and n is at least 1. Suitable Y groups can be derived from polyols such as glycerol, pentaerythritol; sugars such as raffinose, maltodextrose, galactose, sucrose, glucose, xylose, fructose, maltose, lactose, mannose and erythrose; sugar alcohols such as erythritol, xylitol, malitol, mannitol and sorbitol; and anhydrides of sugar alcohols such as sorbitan.

One class of suitable polyhydroxy fatty acid esters for use in the present invention comprises certain sorbitan esters, such as sorbitan esters of C₁₆-C₂₂ saturated fatty acids.

Immobilizing agents include agents that are may prevent migration of the emollient into the fibrous structure such that the emollient remain primarily on the surface of the fibrous structure and/or sanitary tissue product and/or on the surface treating composition on a surface of the fibrous structure and/or sanitary tissue product and facilitate transfer of the lotion composition to a user's skin. Immobilizing agents may function as viscosity increasing agents and/or gelling agents.

Nonlimiting examples of suitable immobilizing agents include waxes (such as ceresin wax, ozokerite, microcrystalline wax, petroleum waxes, fisher tropsh waxes, silicone waxes, paraffin waxes), fatty alcohols (such as cetyl, cetaryl, cetearyl and/or stearyl alcohol), fatty acids and their salts (such as metal salts of stearic acid), mono and polyhydroxy fatty acid esters, mono and polyhydroxy fatty acid amides, silica and silica derivatives, gelling agents, thickeners and mixtures thereof.

In one example, the lotion composition comprises at least one immobilizing agent and at least one emollient.

In another example, the lotion composition may comprise one or more volatile agents.

It has been unexpectedly found that a fibrous structure comprising a lotion composition and a volatile agent, especially an unrestrained volatile agent, provides an olfactory benefit to a consumer of such a fibrous structure for a longer time than a fibrous structure that lacks a lotion composition but has an unrestrained volatile agent. In other words, it has been found that the lotion composition facilitates the retention of the olfactory benefit provided by an unrestrained volatile agent present on a fibrous structure.

### Skin Benefit Agent

One or more skin benefit agents may be included in the lotion composition of the present invention. If a skin benefit agent is included in the lotion composition, it may be present in the lotion composition at a level of from about 0.5% to about 80% and/or 0.5% to about 70% and/or from about 5% to about 60% by weight of the lotion.

Nonlimiting examples of skin benefit agents include zinc oxide, vitamins, such as Vitamin B3 and/or Vitamin E, sucrose esters of fatty acids, such as Sefose 1618S (commercially available from Procter & Gamble Chemicals), antiviral agents, anti-inflammatory compounds, lipid, inorganic anions, inorganic cations, protease inhibitors, sequestration agents, chamomile extracts, aloe vera, calendula officinalis, alpha bisalbolol, Vitamin E acetate and mixtures thereof.

Nonlimiting examples of suitable skin benefit agents include fats, fatty acids, fatty acid esters, fatty alcohols, triglycerides, phospholipids, mineral oils, essential oils, sterols, sterol esters, emollients, waxes, humectants and combinations thereof.

### Other Ingredients in Lotion Composition

Other optional ingredients that may be included in the lotion composition include vehicles, perfumes, especially long lasting and/or enduring perfumes, antibacterial actives, antiviral actives, disinfectants, pharmaceutical actives, film formers, deodorants, opacifiers, astringents and solvents.

### Vehicle

As used herein a “vehicle” is a material that can be used to dilute and/or emulsify agents forming the surface treating composition and/or lotion composition to form a dispersion/emulsion. Suitable materials for use as the vehicle of the present invention include hydroxyl functional liquids, including but not limited to water.

### Surface Softening Agent

Surface softening agents include any chemical ingredient which imparts a lubricious feel to the fibrous structure and/or sanitary tissue product of the present invention and are present on a surface of the fibrous structure at a level greater than the remainder of the fibrous structure. Nonlimiting examples of suitable surface softening agents includes, for exemplary purposes only, basic waxes such as paraffin and beeswax silicone gels as well as petrolatum and more complex lubricants and emollients such as quaternary ammonium compounds with long (C8-C22) hydrocarbyl chains, functional silicones, and long (C8-C22) hydrocarbyl chain-bearing compounds possessing functional groups such as amines, acids, alcohols and esters.

### Processes for Making

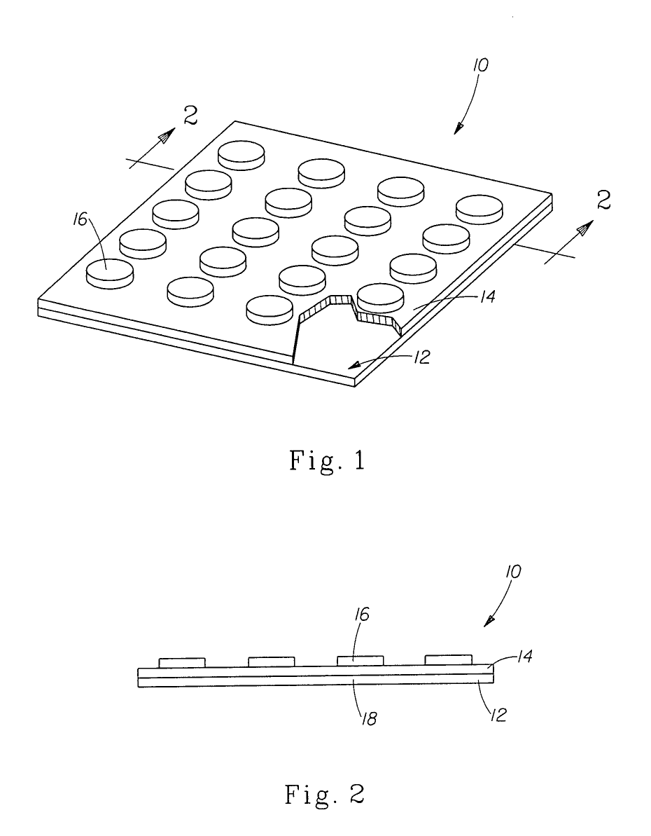

As shown in FIGS. 1 and 2, in one example, a sanitary tissue product, such as a facial tissue, 10 of the present invention comprises a fibrous structure 12. The fibrous structure 12 comprises a lotion composition 14 and a volatile agent 16. The fibrous structure 12 comprises one or more fibers 18.

In one example, a process for making a sanitary tissue product 10 in accordance with the present invention comprises the step of providing a fibrous structure 12; applying a lotion composition 14 to the a surface of the fibrous structure 12; and applying a volatile agent 16 to the fibrous structure 12 and/or the lotion composition 14.

Another nonlimiting example of a suitable method for applying the lotion composition 14 and/or volatile agent 16 to a fibrous structure 12 includes spraying the lotion composition 14 and/or the volatile agent 16 on one or more surfaces of the fibrous structure 12. The lotion composition 14 and/or the volatile agent 16 may be applied to the fibrous structure 12 at any point or points during the papermaking and/or converting processes for making the fibrous structure 12. In one example, the lotion composition 14 is applied to the fibrous structure 12 prior to the application of the volatile agent 16 to the fibrous structure 12.

Other nonlimiting examples of suitable method for contacting one or more surfaces of the fibrous structure 12 with a lotion composition 14 and/or a volatile agent 16 include dipping, brushing, extruding, such as slot extruding, and/or printing the lotion composition 14 and/or the volatile agent 16 onto one or more surfaces of the fibrous structure 12.

In one example, a stack of one or more fibrous structures 12 may be oriented such that the volatile agent 16 may initially contact edges of the fibrous structures 16 upon application, such as spraying, of the volatile agent 16. The volatile agent 16 then may migrate substantially on the surface and/or throughout the fibrous structure 12, especially if the fibrous structure 12 comprises a lotion composition 14. The stack of fibrous structures may be in any orientation such as interleaved, non-interleaved, C-folded, Z-folded, tri-folded, quad-folded, and the like.

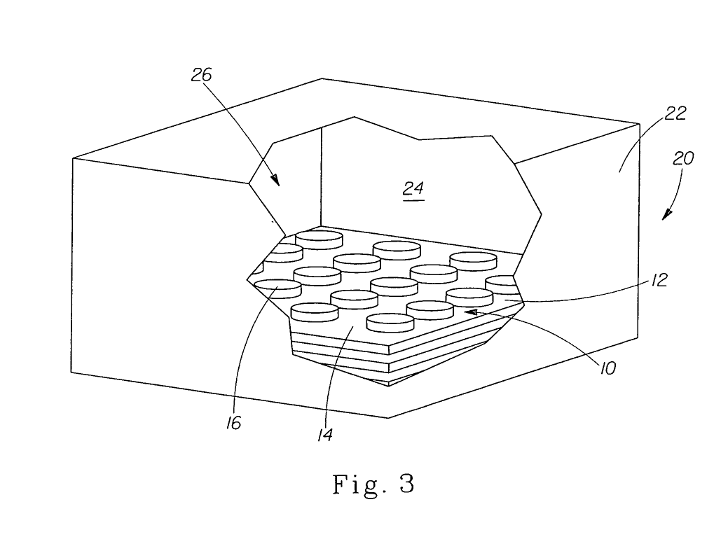

As shown in FIG. 3, in one example, an article of manufacture 20, such as a box containing facial tissues, comprises a container 22. The container 22 comprises one or more interior surfaces 24 that define an interior volume. One or more sanitary tissue products 10 are housed within the interior volume. The space within the interior volume that is not occupied by the sanitary tissue products 10 is called the void volume 26 and/or headspace.

The container 22 may be in the form of a blank (ready to be folded and/or molded into a complete or substantially complete container) or in a completed or substantially completed container that defines a void volume 26.

The container 22 may comprise any suitable material known to those of skill in the art. Nonlimiting examples of such suitable materials include paper, paper board, cardboard, corrugated paper, plastic. Nonlimiting examples of suitable materials for the container include injection molded plastic, thermoformed plastic, blow-molded plastic, flexible film and combinations thereof.

In one example, the container 22 may be made from a vapor and/or liquid impermeable material. In another example, the container 22 may be treated by a material to make the container vapor and/or liquid impermeable. A nonlimiting example of a material that can be used to treat the container 22 is a wax. The container 22 may comprise wax-impregnated paper. One or more surfaces 24 of the container 22 may comprise metallized polyester. The metallized polyester may be visible on the interior and exterior surfaces of the container 22. In other examples, the material used to make the container 22 may be a laminate and/or may be coated with some material that aids in inhibiting and/or preventing the release of the volatile agent 16 from the container.

In one example, the article of manufacture 20 may be completely and/or substantially wrap with a flow wrap and/or shrink wrap to aid in inhibiting and/or preventing the release of the volatile agent 16 from the container 22.

In yet another example, the container 22 may be placed within an outer container (not shown) to form an article of manufacture in accordance with the present invention. Nonlimiting examples include a plastic tub within a cardboard carton and/or a flow wrap container within a plastic tub.

In another example, the container 22 may be structurally designed to inhibit and/or prevent the release of the volatile agent 16, in any form, to the external environment surrounding the container 22. One way to do this is by designing the flaps of the container 22 to form a substantially air tight seal when closed. Another way is to use a material for the container 22 that is impermeable to the volatile agent 16. Still another way is to use sealing techniques and/or materials that when used on the container 22 during formation of the container 22, seals the container 22 more effectively. Nonlimiting examples of suitable sealing techniques include heat sealing, RF sealing and/or IR sealing.

A volatile agent 16 may be applied to one or more surfaces of the container 22. The volatile agent 16 may volatilize such that the volatile agent 16 becomes present at a measurable level within the void volume 26. In another example, the volatile agent 16 may transfer, as a liquid to one or more fibrous structures 12 by contacting the one or more fibrous structures 12 within the container 22.

A nonlimiting example of a suitable method for applying the volatile agent 16 to one or more surfaces 24 of the container 22 includes applying an adhesive, such as a hot melt adhesive, to the one or more surfaces 24. The adhesive may function to adhere one or more sides of the container together. In one example, the adhesive may be in the form of a sheet or patch that can be adhered to on a surface of the container 22.

Another nonlimiting example of a suitable method for applying the volatile agent 16 to one or more surfaces 24 of the container 22 includes spraying the volatile agent 16 on one or more surfaces 24 of the container 22. The container 22 may be in its blank form and/or it may be in its completed or substantially completed form at the time of the spray application.

Other nonlimiting examples of suitable method for contacting one or more surfaces 24 of the container 22 with a volatile agent 16 include dipping, brushing, extruding, such as slot extruding, and/or printing the volatile agent 16 onto one or more surfaces 24 of the container 22.

Yet another nonlimiting example of a suitable method for applying the volatile agent 16 to one or more surfaces 24 of the container 22 includes applying by any suitable application method the volatile agent 16 to a substrate, such as a fabric swatch, paper sheet, plastic film, such that the substrate can then be attached to one or more surfaces 24 of the container 22.

### EXAMPLE 1

### Volatile Agent Composition

A nonlimiting example of a volatile agent composition suitable for application to a fibrous structure is made as follows. Combine 23.50% w/w of Chinese Camphor, 30.00% w/w of 1-Menthol, 2.00% w/w of C&A Bulgarian Lavender Oil and 44.50% w/w of Eucalyptus oil into a pot mixer in order as listed above. Stir for 30 minutes or until Chinese Camphor and 1-Menthol are fully dissolved. Store at room temperature, about 73° F.±4° F. (about 23° C.±2.2° C.).

### EXAMPLE 2

### Fibrous Strycture Comprising Volatile Agent Composition from Example 1

A nonlimiting example of a fibrous structure comprising a volatile agent composition is made as follows. A bundle of fibrous structures are folded in a C-fold configuration. One end of the C-fold configuration is sprayed with 0.75 g of the volatile agent composition by any suitable spraying technique, such as a pump spray bottle and/or a dosing spray bottle.

The sprayed bundle of fibrous structures may then be inserted into a void volume of a container. The container can then be closed to retain and house the bundle of fibrous structures.

### EXAMPLE 3

### Fibrous Structure Comprising Volatile Agent Composition from Example 1

A nonlimiting example of a fibrous structure comprising a volatile agent composition is made as follows. A bundle of fibrous structures are folded in a C-fold configuration. One end of the C-fold configuration is dosed via a pipette with 0.75 g of the volatile agent composition.

The dosed bundle of fibrous structures may then be inserted into a void volume of a container. The container can then be closed to retain and house the bundle of fibrous structures.

Table I below shows the average product ratings (five point scale: 0=Poor, 25=Fair, 50=Good, 75=Very Good, 100=Excellent) of a fibrous structure of the present invention used for 2 weeks by a representative panel of 273 consumers.

TABLE I

| | Representative Panel |
|---|---|
| Scent Attributes | of 273 Consumers |
| Scent helps me feel like I'm | 89 |
| breathing better | |
| Scent helps me feel cared for when | 89 |
| I have a cold | |
| Offering an appealing new benefit | 91 |
| Help feel cared when have cold | 89 |
| Soothing comfort when have cold | 91 |
| % Prefer vs. Usual tissue when | 90* |
| I have a cold | |

*Percent rather than average product rating

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising a volatile agent wherein the fibrous structure provides a user of the fibrous structure an olfactory benefit upon use wherein the user perceives that the user's nasal passages are providing greater air passage through the nasal passages than before the olfactory benefit.

2. The fibrous structure according to claim 1 wherein the volatile agent comprises an unrestrained volatile agent.

3. The fibrous structure according to claim 1 wherein the volatile agent is present within an oil system.

4. The fibrous structure according to claim 3 wherein the oil system comprises one or more essential oils.

5. The fibrous structure according to claim 1 wherein the fibrous structure further comprises a lotion composition.

6. The fibrous structure according to claim 5 wherein at least a portion of the volatile agent is separate from the lotion composition.

7. The fibrous structure according to claim 1 wherein the volatile agent is extractable from the fibrous structure.

8. The fibrous structure according to claim 1 wherein the volatile agent is uniformly distributed throughout the fibrous structure.

9. The fibrous structure according to claim 1 wherein the volatile agent is selected from the group consisting of: menthol, camphor, eucalyptus oil, lavender oil and mixtures thereof.

10. The fibrous structure according to claim 1 wherein the volatile agent is present at a level of at least about 0.150% by weight of the fibrous structure.

11. A single- or multi-ply sanitary tissue product comprising a fibrous structure according to claim 1.

12. An article of manufacture comprising a container and one or more sanitary tissue products according to claim 11 housed within the container.

13. The article of manufacture according to claim 12 wherein the container is made from a vapor impermeable material.

14. A process for making a fibrous structure that provides a consumer recognizable olfactory benefit upon use by a consumer wherein the consumer perceives that the consumer's nasal passages are providing greater air passage through the nasal passages than before the olfactory benefit, the process comprises the step of associating a fibrous structure with a volatile agent.

15. The process according to claim 14 wherein the step of associating a fibrous structure with a volatile agent comprises applying a volatile agent to one or more surfaces of the fibrous structure.

16. The process according to claim 15 wherein the volatile agent is mixed with one or more essential oils prior to application to the one or more surfaces of the fibrous structure.

17. The process according to claim 14 wherein the process further comprises applying a lotion composition to one or more surfaces of the fibrous structure.

18. The process according to claim 17 wherein the volatile agent is applied to the fibrous structure after the lotion composition has been applied to the one or more surfaces of the fibrous structure.

19. A process for making an article of manufacture, the process comprises the steps of:
a. providing a container;
b. positioning one or more fibrous structures into the container such that the container houses the one or more fibrous structures;
c. associating the container and/or fibrous structures with a volatile agent such that the volatile agent provides a consumer recognizable olfactory benefit to a consumer upon use.

20. The process according to claim 19 wherein the step of associating the container and/or fibrous structures with a volatile agent comprises applying a volatile agent to one or more surfaces of the container.

21. A fibrous structure comprising a lotion composition and one or more unrestrained volatile agents.
